(19) United States
(12) Patent Application Publication
(10) Pub. No.: US 2006/0290889 A1
(43) Pub. Date: Dec. 28, 2006

(54) Three-Dimensional Stereoscopic Projection Architectures

(75) Inventors: Michael G. Robinson, Boulder, CO (US); Jianmin Chen, Superior, CO (US); Gary D. Sharp, Boulder, CO (US); John Korah, Denver, CO (US)

Correspondence Address: BAKER & MCKENZIE LLP;PATENT DEPARTMENT, 2001 ROSS AVENUE, SUITE 2300, DALLAS, TX, 75201, US

(73) Assignee: COLORLINK, INC., Boulder, CO (US)

(21) Appl. No.: 11/423,574

(22) Filed: Jun. 12, 2006

Related U.S. Application Data
(60) Provisional application No. 60/689,277, filed on Jun. 10, 2005.

(51) Int. Cl. G03B 21/00

(52) U.S. Cl. 353/8

(57) ABSTRACT

Described are illumination systems for providing visible images. The systems include a first image projection sub-system operable to provide a first stereo-image output formed by light having a first polarization; a second image projection sub-system operable to provide a second stereo-image output formed by light having a second polarization; a projection means wherein the projection means projects the first and second stereo-image outputs onto a display through a common lens; wherein the system is operable to provide orthogonal first polarization and second polarization. Typically, the first and second image outputs are formed from light having orthogonal polarizations and the system is preferably switchable between providing orthogonal and non-orthogonal first and second images. In preferred embodiments the system is operable to provide nonstereo images while providing increased resolution. Preferred systems include a common light source and a common projection lens. Some systems include digital micromirror devices and liquid crystal on silicon technologies. Related methods of providing visible images are also disclosed.

### CROSS-REFERENCE TO RELATED APPLICATIONS

This application claims priority to U.S. Provisional Application Serial No. 60/689,277, filed Jun. 10, 2005, entitled “Three-dimensional Stereoscopic Projection Architectures” which is incorporated herein by reference in its entirety.

### TECHNICAL FIELD

Disclosed embodiments herein relate to optical architectures that project polarization-encoded three-dimensional stereoscopic images. Embodiments of the invention comprise the concept of combining the output of two physically separate full-image projection sub-systems, but in preferred embodiments employing a common projection lens and in most cases a common light source. A disclosed full-image sub-system comprises input/output beam separation with one or more modulating microdisplays.

### BACKGROUND

Three-dimensional displays can be of several forms. Those such as holographic displays form an exact optical representation of three-dimensional objects through phase and amplitude modulation of light. Others recreate three-dimensional information using volume displays such as a series of synchronized modulating two-dimensional screens. Although, these approaches more closely reproduce true three-dimensional images, they are very demanding of hardware and at present can only form very crude images. A more practical approach is to form stereoscopic images in which one image is seen only by the right eye and a second image by the left. The difference between the images yields depth information, thereby providing a strong three-dimensional sensation whereby objects appear to be only a few meters away from a viewer in a cinema environment.

Conventionally, stereoscopic images are viewed through eyewear that discriminates between the eyes. Eyewear can discriminate through color wherein one eye can be made to see one portion of the visible spectrum while the other eye sees a complementary portion of the spectrum. Encoding the stereoscopic images in the same color bands can yield a three-dimensional sensation although the obvious difference in what the eyes see causes fatigue. Consequently, other systems and methods of providing three-dimensional images would be useful.

### SUMMARY

Disclosed in this application is an illumination system and method of forming visible images. The illumination systems include a first image projection sub-system that provides a first stereo-image output formed by light having a first polarization; a second image projection sub-system that provides a second stereo-image output formed by light having a second polarization; and a projection means. The systems described herein are operable to provide orthogonal first polarization and second polarizations and in preferred embodiments are operable to switch between a first mode that provides orthogonal first and second polarizations and a second mode that provides nonorthogonal first and second polarizations.

In some embodiments the first and second polarizations are linear polarization states. Another polarization-based solution is to use orthogonal left and right circularly polarized light for the two stereo image channels.

Disclosed embodiments have the ability to switch between two-dimensional and three-dimensional modes, where two-dimensional imagery is achieved by displaying substantially identical stereo-images. When operating in a two-dimensional mode, the images may be offset by a sub-pixel amount in orthogonal linear dimensions to form high-resolution two-dimensional images from low-resolution, low cost, small modulators. In this case, part-pixel modulation can be achieved with suitably encoded images. In one embodiment, two digital micromirror device modulators are used to form the stereoscopic images, whereas another uses liquid crystal-(LC) or liquid on silicon-(LCOS) based imagers. Preferably, each polarization component of the source is used for each of the two sub-system modulation kernels, especially when coupling light onto small, cost-effective microdisplays.

In some embodiments of the invention, the disclosed systems include the two modulating sub-systems operating together with a common lamp and a common projection lens to form two images simultaneously having orthogonal polarizations. Embodiments include two-panel digital micromirror device-based systems, two- and four-panel LCOS systems, and six-panel LC systems.

Disclosed embodiments provide methods of providing stereoscopic visible images that include providing a first stereo-image output formed by light having a first polarization; providing a second stereo-image output formed by light having a second polarization; and projecting the first and second stereo-image outputs onto a display; wherein the first image output is provided by a first stereo-image projection sub-system and the second stereo-image output is provided by a second image projection sub-system; wherein the first and second sub-systems are operable to provide orthogonal first and second polarizations.

In particular embodiments, the first and second stereo-image outputs are projected with a projecting means that includes a light combining element arranged in the system to receive the first and second stereo-image outputs, the light combining element operable to combine and directly or indirectly project the first and second stereo-image outputs from the first and second image projection sub-systems onto a display through a common lens. One light combining element includes a polarizing beam splitter that is operable to combine the first and second stereo-image outputs from the first and second image projection sub-systems. While the light combining element typically includes a polarizing beam splitter, other light combining elements may be used. Typically the projection means also includes at least one light source and a common projection lens. Preferred methods use a single light source and a single projection lens. Some methods further include sequentially or alternatingly providing selected color frames from the first and second projection sub-systems to the at least one microdisplay.

### BRIEF DESCRIPTION OF THE DRAWINGS

For a more complete understanding of embodiments of the invention, and features of the systems and methods herein, reference is now made to the following descriptions taken in conjunction with the accompanying drawings, in which:

FIG. 1 illustrates a two-panel digital micromirror device system as disclosed herein;

FIG. 2a and 2b illustrate two-panel liquid crystal on silicon (LCOS) systems as disclosed herein;

FIG. 3 illustrates a four-panel liquid LCOS system as disclosed herein;

FIG. 4 illustrates a six-panel LCOS system as disclosed herein; and

FIG. 5a,b and c illustrate two-panel systems with color sharing.

### DETAILED DESCRIPTION OF THE PREFERRED EMBODIMENTS

With any polarization-based discrimination technique, complete two-dimensional images are formed with orthogonal polarization states. Although this can be done by spatially patterning direct-view displays with micro-polarizers, or by time-sequentially altering the output polarization state of a display in synchronization with time-sequential images, one solution is to continuously display two full-color, high-resolution, orthogonal polarized images. Since this would demand, in general, two displays, it well-suited to projection systems where the image modulator is compact and potentially low cost.

Embodiments of this invention employ microdisplay projection systems that produce stereo-images with orthogonal polarization states using a common illumination source and a common projection lens. The term “stereo-images” refers to a pair of images that form slightly different views, usually by a rotational off-set, of a scene on each retina, thereby providing a three-dimensional appearance to the scene. Pairs of images that provide substantially the same view are perceived to lack three-dimensionality and are referred to as nonstereo-images. The common illumination source and common projection lens serves to provide, respectively, color balance and image registration. Using separate sources for each image can lead to color balance mismatch, especially as currently used high-brightness sources age. A single projection lens provides for registration of the images before the projection lens, and registration in this approach is therefore maintained for different imaging settings such as the distance and angle to screen and tolerance of zoom.

In situations where the three-dimensional-capable systems described herein are used for displaying two-dimensional images, there is a redundancy of hardware—there being no need in this instance to have separate polarization sub-systems for the handling of the polarization-encoded images. It is however possible to use this extra hardware to improve image resolution. By displaying one image offset by half a pixel in both linear dimensions, and by altering the image content to represent sub-pixel features, higher resolution can be realized. The embodiments described herein are therefore able to deliver higher-resolution two-dimensional images with two lower-resolution projection modulators, together with offering the additional feature of being able to display stereo imagery at the native modulator resolution.

In one embodiment, two digital micromirror device modulators, such as those used by Texas Instruments in its Digital Light Processing™ architectures, are used to form the stereoscopic images, whereas another uses liquid crystal (LC) or liquid crystal on silicon (LCOS) based imagers. Two-dimensional LC systems typically use three panels to achieve full-color imagery, so one embodiment of this invention combines two three-panel sub-systems or kernels to form a six-panel, two-dimensional/three-dimensional system. In other embodiments, the system combines one- or two-panel liquid crystal on silicon kernels thereby providing 2-panel or 4-panel temporal color kernels.

Some embodiments provide for color sharing. One such embodiments uses color-sequential sub-systems operable to provide the color sharing between first and second channels. An example would be in a digital micromirror device system where RGB (Red, Green, Blue) color frames sequentially illuminate a panel to form a color image. Generally, in single-panel systems, an amount of light forming the complementary colors is lost. By introducing a system with two kernels, the complementary color can be used to illuminate the second kernel. To get full-color imagery from both kernels, and therefore into both stereoscopic images, the primary colors are alternated between sub-systems. Since each image is formed from the summation of primary and complementary colors, the maximum three-dimensional color gamut is distorted with respect to standard video projection systems and correction and some accompanying light loss may be necessary in those instances.

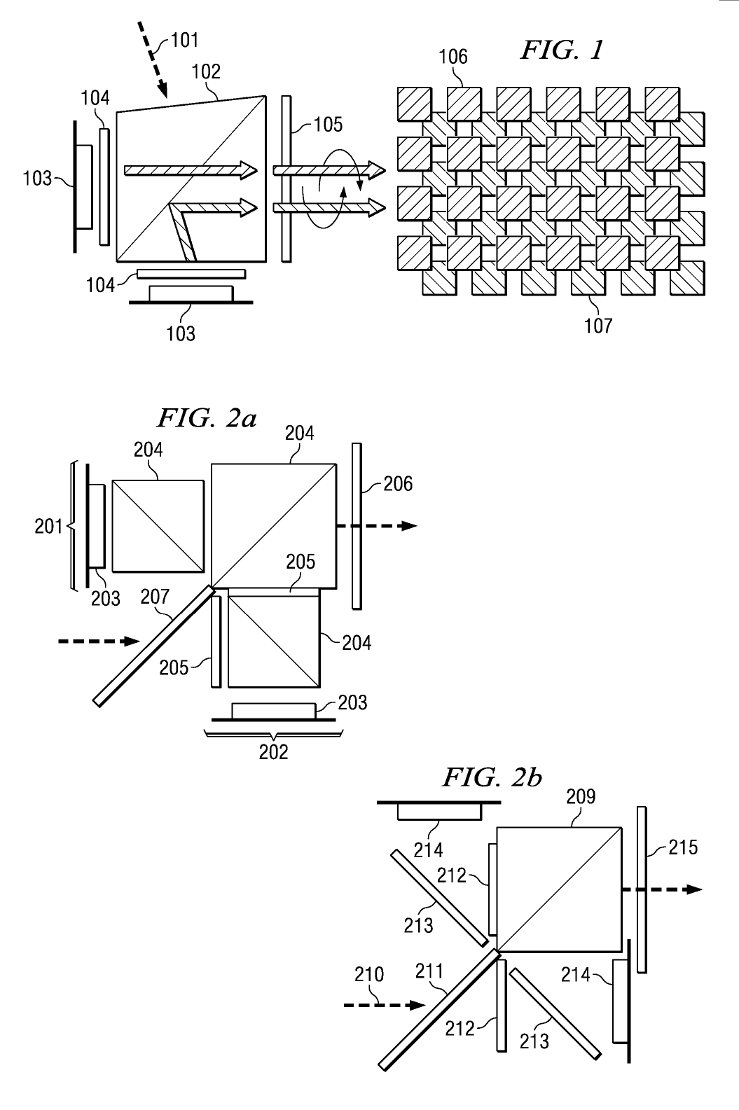

FIG. 1 illustrates an exemplary embodiment of a two-panel digital micromirror device system. Unpolarized, white illumination light 101 enters an off-45° polarizing beam splitter (PBS) 102, which acts to split the unpolarized, white light 101 into its two orthogonal polarization components. Each illuminates a digital micromirror device panel 103 by first passing through a 45°-oriented achromatic quarter-wave plate (QWP) 104 adjacent each panel 103. The purpose of the quarter-wave plates is to alter the polarization state of reflected light from each panel. Modulation between “ON” and “OFF” pixels is achieved in the conventional manner by deflecting light into and away from the capture of the projection lens (not shown). In this way the contrast of the system is determined from scattering and unwanted light collection and not from polarization preservation. Contrasts similar to conventional digital micromirror device systems can therefore be expected. Light that is deflected from “ON” pixels is directed toward the projection lens either by transmission through or reflection off the polarization beam splitter. In this way they have substantially orthogonal polarization states.

Introducing an achromatic quarter-wave plate 105 at the exit of the system 100 produces orthogonal, circularly polarized light for each channel. It should be realized, however, that any birefringent component can be introduced at the exit and the orthogonality between the states will be maintained. Matching the external component with identical, orthogonally-oriented plates at each eyepiece will return the channel polarizations to linear to be analyzed by linear polarizers. In this way, crosstalk between channels can be limited in principle to the extent to which the original states are orthogonal.

The extent to which the polarizations are orthogonal is determined by the product of the polarization beam splitter's p-reflection (Rₚ) and the quarter-wave plate leakage. Leakage in this case is determined by the leakage of light between crossed polarizers of two stacked 45°-oriented quarter-wave plates (collectively, a half-wave plate). For good projection polarization beam splitters, Rₚ<5% and achromatic quarter-wave plate leakage can be less than 2% throughout the visible spectrum. Crosstalk from component performance would therefore be expected to be below 2×0.05×0.02=0.002 or 0.2%.

In disclosed embodiments, below 1% crosstalk yields a very good three-dimensional display, although the scope of the claims should not be construed to cover only systems with certain crosstalk performance. This principle of claim construction applies for other disclosed embodiments herein, and thus the claims should be construed in accordance with their terms set forth in any patent ultimately issuing from this application. Accordingly, the claims should not be limited by the features or limitations described in this or any other disclosed embodiment.

In practice, matching the eyewear to the output of the system will be non-ideal and greater crosstalk can be expected. Also, it has been assumed that the digital micromirror device panels themselves do not depolarize the light. Since pixels consist essentially of aluminum mirrors, no significant depolarization would be expected, although some contribution derives from edge scattering. What is more likely to deteriorate polarization integrity is the stressed cover glass encapsulating the digital micromirror device chip. Stress-induced birefringence can cause serious depolarization and it is expected that the standard digital micromirror device component packaging would have to be altered to accommodate polarization preservation.

Color in this system is formed through color-sequential illumination. As with conventional digital micromirror device systems, this may be done with a color wheel, since no polarization demands are placed on the illumination. The illumination system would therefore constitute a conventional source such as an ultra high pressure (UHP) mercury lamp focused with an elliptical reflector into a rectangular cross-section light pipe. Before entering the light pipe, the beam would pass through the color wheel, which through rotation of color segments is able to break the beam into primary color sequential illumination frames. Synchronization between the panel modulation and these color frames allows for full-color representation. Imaging onto panels via relay optics occurs after exiting the light pipe. Since no polarization conversion is needed, the exiting aperture can be imaged with minimal light loss onto small panels. Exemplary small panels are approximately 0.5 inches diagonally. Envisioned embodiments may include LED illuminators allowing temporal control of color by direct modulation, avoiding using a color wheel.

FIG. 1 also shows diagrammatically the overlapping pixel patterns 106, 107 which allow higher resolution imagery to be realized. Such overlapping patterns 106, 107 mimics, in a time stationary manner, the so-called “wobbling” technique known in the art to enhance resolution. This method of increasing resolution is in its own right a significant cost advantage since yield rates of smaller chips are significantly higher than those with four times the area making two half resolution chips far less costly than a single chip with full resolution. This approach is particularly advantageous in the embodiments disclosed herein, however, because of the synergies of using the sub-systems employed to achieve three-dimensional images to provide higher-resolution two-dimensional images without the need for increased hardware.

FIG. 2a illustrates a second embodiment based on LCOS technology comprising two single-panel modulation sub-systems 201, 202, each of which consists of a panel 203 and polarizing beam splitter 204, and optionally half-wave plate 205. The sub-systems 201, 202 operate by first allowing a polarized illumination beam to be incident on the panel 203 via reflection off a polarization beam splitter 204, and second by allowing light modulated in polarization to be transmitted through the polarization beam splitter 203 toward a projection optic 206. In this way, these sub-systems comprise full-color modulation kernels when operated in synchronization with sequential color illumination.

Initial separation of the unpolarized input beam 101, 207 is carried out via a polarization beam splitter, which is shown in the diagram as a wire-grid plate 208.

To ensure high contrast from the individual kernels, pre-polarizers (not shown) may be employed at the entrance of each of the polarization beam splitters 204 associated with the two kernels. This ensures any unwanted p-polarization entering the PBSs do not get reflected toward the panels. Polarization beam splitters typically reflect a significant amount (˜5%) of p-polarized light. However, since the input polarization beam splitter typically ensures good linear polarization for its transmitted beam, a single pre-polarizer in the reflected channel of the input polarization beam splitter would probably suffice to mitigate the polarization beam splitter's unwanted reflection of p-polarized light.

The output from one of the kernels can be altered with, for example, an achromatic, 45°-oriented, half-wave plate (HWP) such that recombination of each sub-system output can be accomplished with a combining polarization beam splitter. This approach ensures orthogonal polarization states exist for light emanating from each panel. Further optical components such as a 45°-oriented quarter-wave plate can transform the output to orthogonal circularly polarized output states if desired.

Once again a color wheel in conjunction with a ultra high pressure, UHP, lamp can be used to form the appropriate illumination beam as for the first embodiment, and again there is no need to introduce polarization conversion.

High-resolution two-dimensional imagery can also be realized by offsetting the individual projected images as described above.

FIG. 2b illustrates an embodiment wherein a wire-grid plate polarization beam splitter 209 as part of the two modulating sub-systems is employed. In this embodiment, unpolarized white light 210 enters the polarization beam splitter 211 which directs the polarized beams though half-wave plates 212 and polarization beam splitters 213 onto panels 214 after which the beams exit through a quarter-wave plate 215 oriented at 45°.

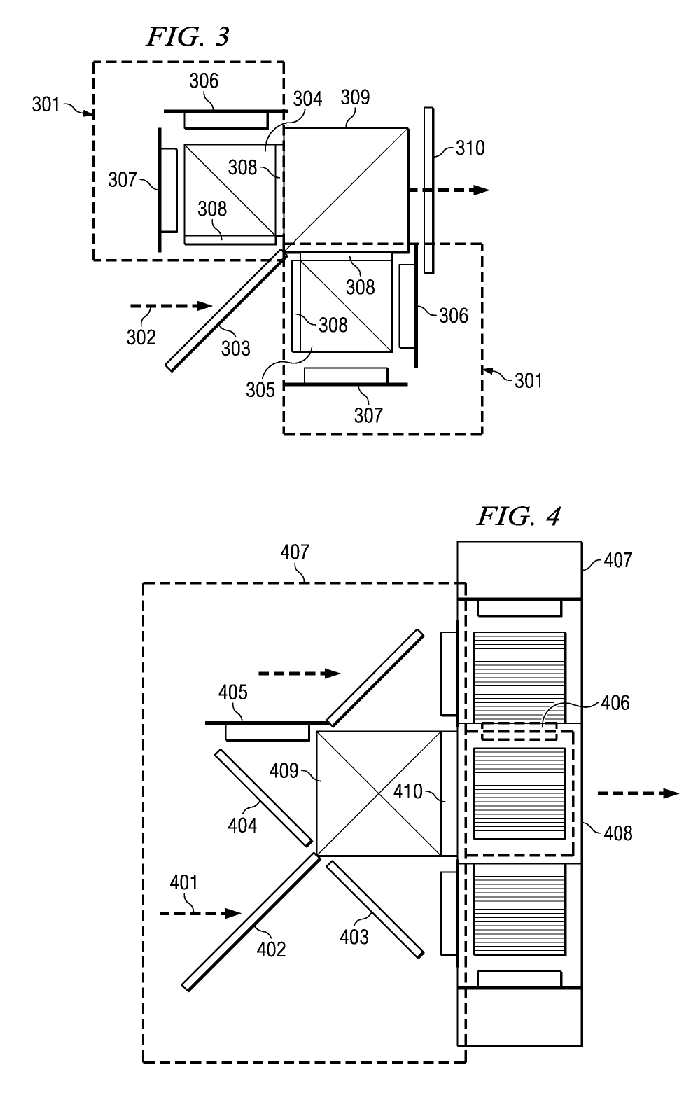

FIG. 3 illustrates an embodiment that employs two, 2-panel liquid crystal on silicon kernels 301. Unpolarized white light 302 is directed toward polarization beam splitter 303 splitting the white light 302 and directing the resulting beams to polarization beam splitters 304 and 305 to direct the toward two liquid crystal on silicon panels 306 and 307 of each kernal 301. Employing suitable retarder stack filters (RSFs) 308 at the entrance and exit of each sub-system 301, each comprising panels 306, 307, allows for un-polarized yellow and magenta sequentially modulated input illumination to be used with orthogonal polarized output imagery that is passed from polarization beam splitter 309 and through 45°-oriented quarter-wave plate 310. Once again, high-resolution two-dimensional imaging can be realized and lower resolution three-dimensional with suitable eyewear.

FIG. 4 schematically represents a six-panel liquid crystal on silicon system embodiment that employs two 3-panel wire grid sub-systems. The outputs of these two sub-systems are combined by an output polarization beam splitter. As drawn the output of the first system drawn to the right of the figure emits modulated light from left to right whereas the second system emits out of the page as drawn. The combining PBS 408 then deflects this second output combining it with the first thus allowing a single lens to image simultaneously the orthogonally polarized outputs. For each system, unpolarized, white light 401 interacts with polarization beam splitters 402, 403, 404, which may be a wire grid polarization beam splitter. Resulting beams are directed onto a panel 405, 406, in each of the sub-systems 407. Prior to the output polarization beam splitter 408, the polarizations of the two exiting beams from each sub-system 407 should require polarization manipulation. Conventional X-cube systems such as 409 yield opposite polarization states for projected green and magenta light. Using a green-magenta (GM) retarder stack filter (RSF) 410 at the exit of one system 407 and an magenta-green retarder stack filter (not shown) at the exit of the second subsystem 408 ensures correct recombination of the beams with the desired orthogonal polarizations. A top-view of one of the sub-systems 407 is indicated by the hashed rectangle on the left portion of FIG. 4. The second sub-system 407 is shown into the page behind the output polarization beam splitter 408. Related six-panel embodiments may combine two MacNeille-based three-panel sub-systems.

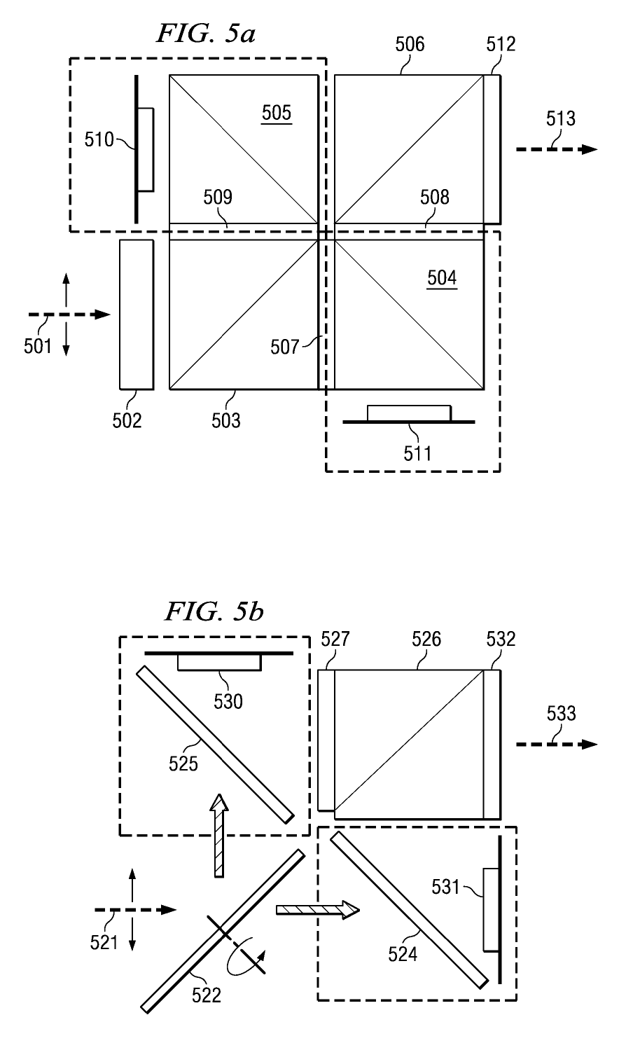

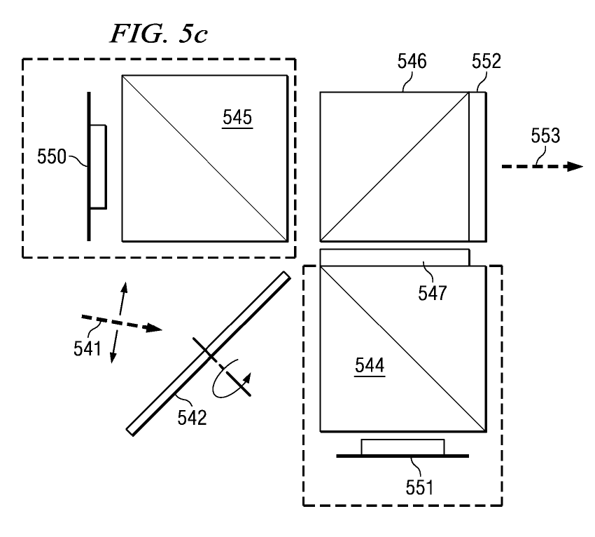

FIGS. 5a-c illustrate two-panel embodiments that employ color sharing between the channels for increased throughput. In the embodiment of FIG. 5a, two single-panel liquid crystal on silicon sub-systems are employed (indicated by the hashed lines in the figure) whose illumination is color-coded by a liquid crystal based polarization ColorSwitch™ 502. For every primary color exiting the ColorSwitch™ with a given polarization state, the complementary color band has the opposite polarization. By sequencing through the three RGB primary and then the three CMY (Cyan, Magenta, Yellow) complementary colors, both panels 510 and 511 are illuminated identically as a time average. Consider for example the situation when the ColorSwitch™ 502 creates p- and s-polarized red and cyan light respectively form the input polarized white light beam 501. The red light passes through the PBS 503 and is transformed in polarization to s- by the achromatic polarization rotator element 507. It then reflects off PBS 504, to illuminate panel 511. The reflected red light that is modulated in polarization by panel 511 is transmitted through PBS 504 to be again be transformed in polarization by the achromatic polarization rotator 508. Finally, the red light deflects off the output PBS 506 and is imaged with a projection lens. Simultaneously, the s-polarized cyan portion of the input white light is reflected off the input PBS 503, transformed in polarization by achromatic rotator 509 so that it illuminates panel 510. Its modulated component passes through PBSs 505 and 506 to form a combined beam 513with modulated red light. Imaging of both red and cyan light is then accomplished with a single projection lens (not shown). An optically isolating 45° quarter-wave plate 512 is often incorporated at the output to ensure circularly polarized light enters the projection lens allowing head tilt tolerance when viewed as two 3D stereoscopic with circular analyzing eyewear. Placing this before the projection lens also acts to isolate reflections from the lens but does demand polarization preserving projection optics.

Full-color images representing the two projected channels is achieved with synchronization of the panels with the illumination. As stated earlier to get correct color balance light would in general have to be lost but a compromise between color fidelity and brightness would still offer significant advantages over a conventional 2×1 panel approach.

FIG. 5b illustrates a color-sharing embodiment in which two one-panel wire-grid-based liquid crystal on silicon sub-systems are illuminated with complementary colors via a rotating color wheel beam splitter 522. Here complimentary colors transmit through the wire grid PBS plates 524 and 525 to be independently modulated by panels 530 and 531. Achromatic rotation element 527 ensures opposite polarized outputs from the two sub-systems are combined by the output PBS 526 prior to entering the imaging optic or projection lens. Although not shown in the schematic figure, such a dynamic beam splitter wheel 522 might require relay optical elements to avoid unacceptable color mixing as the segment boundaries bisect the incoming beam.

FIG. 5c shows a color-sharing embodiment similar in concept to that in FIG. 5b utilizing TIR prisms 545 and 544, digital micromirror panels 550, 551 and a rotating color wheel beam splitter 542. Here again the p-polarized input beam 541 is split into complementary colors but remains unchanged in polarization prior to being modulated by the DMD panels 550, 551. To achieve the combination of output light emanating from each of the two single-panel sub-systems prior to imaging with a single projection lens, an achromatic polarization rotator element 547 acts to transform the modulated light from panel 551 into s-polarization. The output PBS 552 then combines the two modulated beams. An optional QWP 552 is present at the exit to encode the output imaging light with orthogonal polarization states. Cycling through each of the primary colors and their complements ensures each subsystem produces a full-color image for high quality stereo viewing or full-color high resolution offset image formation.

In color-shared systems, a single polarization input state is preferred since color is the means by which the illumination discriminates between colors at any given instant. For this reason, polarization conversion prior to entering the architecture would increase the overall brightness for most microdisplay panels, such as diagonal panels of approximately 0.7 inches.

It will be appreciated by those of ordinary skill in the art that the invention can be embodied in other specific forms without departing from the spirit or essential character thereof. For example, one skilled in the art will appreciate that the two methods of modulating color can be interchanged as desired in the color sharing cases described. The presently disclosed embodiments are therefore considered in all respects to be illustrative and not restrictive. The scope of the invention is indicated by the appended claims rather than the foregoing description, and all changes that come within the meaning and ranges of equivalents thereof are intended to be embraced therein.

Additionally, the section headings herein are provided for consistency with the suggestions under 37 C.F.R. §1.77 or otherwise to provide organizational cues. These headings shall not limit or characterize the invention(s) set out in any claims that may issue from this disclosure. Specifically and by way of example, although the headings refer to a “Technical Field,” the claims should not be limited by the language chosen under this heading to describe the so-called technical field. Further, a description of a technology in the “Background” is not to be construed as an admission that technology is prior art to any invention(s) in this disclosure. Neither is the “Summary” to be considered as a characterization of the invention(s) set forth in the claims found herein. Furthermore, any reference in this disclosure to “invention” in the singular should not be used to argue that there is only a single point of novelty claimed in this disclosure. Multiple inventions may be set forth according to the limitations of the multiple claims associated with this disclosure, and the claims accordingly define the invention(s), and their equivalents, that are protected thereby. In all instances, the scope of the claims shall be considered on their own merits in light of the specification, but should not be constrained by the headings set forth herein.

What is claimed is:

1. A system for providing stereoscopic visible images, comprising:
a) a first image projection sub-system operable to provide a first stereo-image output having a first polarization;
b) a second image projection sub-system operable to provide a second stereo-image output formed by light having a second polarization; and
c) a light combining element arranged in the system to receive the first and second stereo-image outputs, the light combining element operable to combine and directly or indirectly project the first and second stereo-image outputs from the first and second image projection sub-systems onto a display through a common lens; and
wherein the system is operable to provide orthogonal first polarization and second polarizations

2. The system of claim 1, wherein the light combining element includes a polarizing beam splitter.

3. The system of claim 1, wherein at least the first or second image projection sub-system includes at least one modulating microdisplay.

4. The system of claim 1, wherein the first image projection sub-system is a full-image projection sub-system.

5. The system of claim 1, wherein the first and second image projection sub-systems each individually comprise a full-image projection sub-system.

6. The system of claim 1, wherein the first polarization is a first circular polarization and the second polarization is a second circular polarization.

7. The system of claim 1, wherein the first image projection sub-system and the second image projection sub-system are capable of providing first and second nonstereo-image outputs having the same polarization.

8. The system of claim 1, wherein the first image projection sub-system continuously displays the first image output.

9. The system of claim 8, wherein the second image projection sub-system continuously displays the second image output.

10. The system of claim 1, wherein the first and second stereo-image outputs derive from a common light source.

11. The system of claim 1, wherein the first image projection sub-system is operable to provide a first non-stereo-image output that comprises sub-pixel features and is offset with respect to a second non-stereo-image output provided by the second image projection subsystem by a sub-pixel amount in both a first linear dimension and a second linear dimension.

12. The system of claim 1, where in the at least one of the first or second image projection sub-systems includes a digital micromirror modulator.

13. The system of claim 1, where in the at least one of the first or second image projection sub-systems includes a liquid crystal-based or liquid crystal on silicon-based imager.

14. The system of claim 1, further including a polarization discriminating viewing apparatus for viewing the first and second image outputs.

15. A system for providing stereoscopic visible images, comprising:
a) a first image projection sub-system operable to provide a first stereo-image output formed by light having a first polarization;
b) a second image projection sub-system operable to provide a second stereo-image output formed by light having a second polarization; and
c) a light combining element arranged in the system to receive the first and second stereo-image outputs, the light combining element operable to combine and directly or indirectly project the first and second stereo-image outputs from the first and second image projection sub-systems onto a display through a common lens;
wherein the system is operable to substantially simultaneously form the first and second stereo-image outputs from orthogonally polarized light; and
wherein the system is operable to provide a first nonstereo-image and a second nonstereo-image, wherein the first nonstereo image output is offset with respect to the second nonstereo-image output by a sub-pixel amount in both a first linear dimension and a second linear dimension.

16. The system of claim 15, wherein the light combining element includes a polarizing beam splitter.

17. The system of claim 15, wherein the display includes at least one modulating microdisplay.

18. A method of providing stereoscopic visible images, comprising:
a) providing a first stereo-image output formed by light having a first polarization;
b) providing a second stereo-image output formed by light having a second polarization; and
c) projecting the first and second stereo-image outputs onto a display through a common lens; and
wherein the first stereo-image output is provided by a first image projection sub-system and the second stereo-image output is provided by a second image projection sub-system; wherein the first and second sub-systems are operable to provide orthogonal first and second polarizations.

19. The method of claim 18, further including combining by a polarizing beam splitter the first and second stereo-image output from each of the first and second sub-systems.

20. The method of claim 18, wherein at least the first or second image projection sub-system projects at least the first or second stereo-image onto at least one modulating microdisplay.

21. The method of claim 20, further comprising sequentially or alternatingly providing selected color frames from the first and second projection sub-systems to the at least one microdisplay.

22. The method of claim 18, wherein the first image projection sub-system is a full-image projection sub-system.

23. The method of claim 18, wherein the first and second image projection sub-systems each individually comprise a full-image projection sub-system.

24. The method of claim 18, wherein the first polarization is a first circular polarization and the second polarization is a second circular polarization.

25. The method of claim 18, wherein the first image projection sub-system and the second image projection sub-system are capable of providing first and second image outputs having the substantially the same polarization.

26. The method of claim 18, wherein the first image projection sub-system continuously displays the first image output.

27. The method of claim 26, wherein the second image projection sub-system continuously displays the second image output.

28. The method of claim 18, wherein the first and second stereo-image outputs derive from a common light source.

29. The method of claim 18, wherein the first image projection sub-system is operable to provide a first nonstereo-image and the second image projection sub-system is operable to a second nonstereo-image, wherein the first nonstereo image output is offset with respect to the second nonstereo-image output by a sub-pixel amount in both a first linear dimension and a second linear dimension.

30. The method of claim 18, wherein at least one of the first or second image projection sub-systems includes a digital micromirror modulator.

31. The method of claim 18, where in at least one of the first or second image projection sub-systems includes a liquid crystal-based or liquid crystal on silicon-based imager.

32. The method of claim 18, further including viewing the first and second image outputs through at least one polarization discriminating viewing apparatus.

33. A method for providing visible images, comprising:
a) forming a first stereo-image output from light having a first polarization;
b) forming a second stereo-image output from light having a second polarization; and
c) projecting the first and second stereo-image output onto a display;
wherein the first and second stereo-images derive from a common light source and are projected onto the display though a common lens;
wherein the first polarization is switchably providable as orthogonal or non-orthogonal with respect to the second polarization; and
wherein projecting the first and second stereo-images includes switchably projecting a first nonstereo-image from a first image projection sub-system and switchably projecting a second nonstereo-image from a second image projection sub-system, wherein the first nonstereo image output is offset with respect to the second nonstereo-image output by a sub-pixel amount in both a first linear dimension and a second linear dimension.
